(19) United States
(12) Patent Application Publication
(10) Pub. No.: US 2016/0313927 A1
(43) Pub. Date: Oct. 27, 2016

(54) METHOD FOR DYNAMICALLY STORING DATA OF TRANSLATION LAYER IN SOLID STATE DISK

(71) Applicant: QUANTA STORAGE INC., Taoyuan City (TW)

(72) Inventors: Cheng-Yi LIN, Taoyuan City (TW); Ying-Kai YU, Taoyuan City (TW); Yi-Long HSIAO, Taoyuan City (TW)

(73) Assignee: QUANTA STORAGE INC., Taoyuan City (TW)

(21) Appl. No.: 15/080,661

(22) Filed: Mar. 25, 2016

(30) Foreign Application Priority Data
Apr. 27, 2015 (CN) 201510204255.4

(51) Int. Cl. G06F 3/06

(52) U.S. Cl. CPC G06F 3/0611; G06F 3/0659; G06F 3/0688

(57) ABSTRACT

A method for dynamically storing data of translation layer in a solid state disk is provided. A data access instruction is sent by a host. Whether the access data is a hot data or a cold data is determined. Whether a flash translation layer (FTL) dynamically established by the SSD is in the partial mapping method is checked. Access rates of different storage medium are compared. The storage position of the hot data of the FTL is adjusted to the storage medium having a faster access rate and the storage position of the cold data of the FTL is adjusted to the storage medium having a slower access rate to increase the access rate.

This application claims the benefit of People's Republic of China application Ser. No. 201510204255.4, filed Apr. 27, 2015, the disclosure of which is incorporated by reference herein in its entirety.

### TECHNICAL FIELD

The disclosure relates in general to a solid state disk (SSD), and more particularly to a method for dynamically storing hot/cold data of translation layer in a solid state disk according to a translation layer which is used for establishing a logical to physical (L2P) table.

### BACKGROUND

Solid state disk (SSD) is a storage device which integrates negative-AND (NAND) flash memory arrays into a single storage device. Since the flash memory is subject to erase times, data needs to be distributed to the flash memory array of the SSD, and a flash translation layer (FTL) is established to manage a cross-reference relationship between the logical address and the physical address of the data stored in the flash memory to facilitate the access of data.

Referring to FIG. 1, a functional block diagram of storage system 1 of an electronic device of the prior art is shown. In the prior art, the electronic device, such as a computer or a mobile phone, includes a host 2 and a solid state disk (SSD). The host 2 includes a central processing unit (CPU) 3, a transmission interface 4 and a dynamic random access memory (DRAM) 9. The CPU 3 sends the logical address of the data to be accessed by the host 2 to the SSD 5 which is connected to the transmission interface 4. The SSD 5 includes a controller 6, a buffer memory 7, and a flash memory array 8. The controller 6 works with the buffer memory 7 to receive the logical address of the data to be accessed by the host 2, and access the data from the corresponding physical address in the flash memory array 8, then store the data to the DRAM 9 for the host 2 to use.

In order to manage the relationship between the logical address of the data and its physical address in the flash memory array 8, when the SSD 5 is started up, the SSD 5 reads the management data of each data block from the flash memory array 8 to form a logical to physical (L2P) table of the logical address and the physical address of the data, and establish a flash translation layer (FTL) to store and manage the L2P table. When the SSD 5 is initialized, the position of the FTL is already established in the buffer memory 7 or the flash memory array 8 by the firmware stored in the flash memory array 8, and cannot be changed any more. The access rate of the DRAM is 10 times faster than the access rate of the flash memory. In the prior art, in order to increase the access rate, the SSD 5 normally takes priority to establish the FTL in the buffer memory 7 belonging to the DRAM type.

In the prior art, the SSD 5 establishes the FTL in the buffer memory 7. However, once the buffer memory 7 is damaged or partly damaged, and cannot have the FTL established thereon, the SSD 5 will be unable to use the FTL to manage the L2P table and access data, and the SSD 5 will become failed. Also, the storage system of the SSD 5 varies with the requirements of the electronic device, and some SSDs are not equipped with the buffer memory. Under such design, the FTL of the SSD 5 will be established on the flash memory array having a slower access rate, making it difficult to increase the access rate of the SSD. Since the SSD 5 of the prior art cannot dynamically change the establishment position of the FTL in response to the change in the storage system of electronic device, the storage position of the hot/cold data of the FTL cannot be dynamically adjusted, and the access rate of the SSD is decreased. Therefore, the SSD still has many problems to resolve in regard to the storage of the hot/cold data of the translation layer.

### SUMMARY

The disclosure is directed to a method for dynamically storing data of translation layer in a solid state disk (SSD). The storage position of the hot/cold data is dynamically selected according to the mapping method of the flash translation layer (FTL) which is dynamically selected during the start-up of the SSD to increase the access efficiency of SSD.

According to one embodiment, a method for dynamically storing data of translation layer in a SSD is provided. The access rates of different storage medium in the selected mapping method are compared. The hot data is dynamically stored in the storage medium having a faster access rate to increase the access efficiency of the SSD.

To achieve the objects of the present invention, a method for dynamically storing data of translation layer in a SSD is disclosed in a first embodiment of the present invention. The method includes following steps. A data access instruction is sent to SSD by a host. Whether the access data is a hot data or a cold data is determined. Whether a FTL dynamically established by a SSD is in the partial mapping method is checked. Access rates of different storage medium in the partial mapping method are compared. The access rates of the storage medium are ranked. The storage position of the hot data of the FTL is adjusted to the storage medium having a faster access rate and the storage position of the cold data of the FTL is adjusted to the storage medium having a slower access rate.

In the present invention, a hot/cold data determination mechanism is established in the host or the SSD. The hot/cold data determination mechanism presets an access times threshold, calculates data access times, and determines the access data as a hot data if the calculated access times exceeds the access times threshold and determines the access data as a cold data if the calculated access times do not exceed the access times threshold. When the FTL dynamically established by the SSD is set in a partial mapping method, which includes flash partial L2P table mapping method, dynamic random access memory (DRAM) partial L2P table mapping method and host partial L2P table mapping method, the storage position of the hot/cold data is adjusted. When the FTL dynamically established by the SSD is set in a non-partial mapping method, which includes dynamic selection full L2P table mapping method and flash array L2P table mapping method, the storage position of the hot/cold data is not adjusted.

A method for dynamically storing data of translation layer in a SSD is disclosed in a second embodiment of the present invention. The method includes following steps. A data access instruction is sent to SSD by a host. Whether the access data is a hot data or a cold data is determined. When it is checked and determined that the FTL dynamically established by the SSD is set in a non-partial mapping method, the storage position of the hot/cold data is not adjusted. When it is checked and determined that the FTL dynamically established by the SSD is set in a partial mapping method, whether the FTL dynamically established by the SSD is set in the flash partial L2P table mapping method is checked. When it is checked and determined that the FTL is in the flash partial L2P table mapping method, the access rates between the buffer memory and the flash memory array are compared. If the access rate of the buffer memory is faster than the access rate of the flash memory array, then the storage position of the hot data of the FTL is adjusted to the buffer memory and the storage position of the cold data of the FTL is adjusted to the flash memory array. When it is determined that the FTL is not set in the flash partial L2P table mapping method, whether the FTL dynamically established by the SSD is set in the DRAM partial L2P table mapping method is checked. When it is determined that the FTL is set in the DRAM partial L2P table mapping method, the access rates between the buffer memory and the DRAM are compared. If the access rate of the buffer memory is faster than the access rate of the DRAM, then the storage position of the hot data of the FTL is adjusted to the buffer memory and the storage position of the cold data of the FTL is adjusted to the DRAM.

In the present invention, when it is determined that the FTL is not set in the DRAM partial L2P table mapping method, whether the FTL dynamically established by the SSD is set in the host partial L2P table mapping method is checked. When it is determined that the FTL is set in the host partial L2P table mapping method, access rates between the DRAM and the flash memory array are compared. If the access rate of the DRAM is faster than the access rate of the flash memory array, then the storage position of the hot data of the FTL is adjusted to the DRAM and the storage position of the cold data of the FTL is adjusted to the flash memory array. If the access rate of the flash memory array is faster than the access rate of the DRAM, then the storage position of the hot data of the FTL is adjusted to the flash memory array and the storage position of the cold data of the FTL is adjusted to the DRAM.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a functional block diagram of storage system of an electronic device of the prior art.

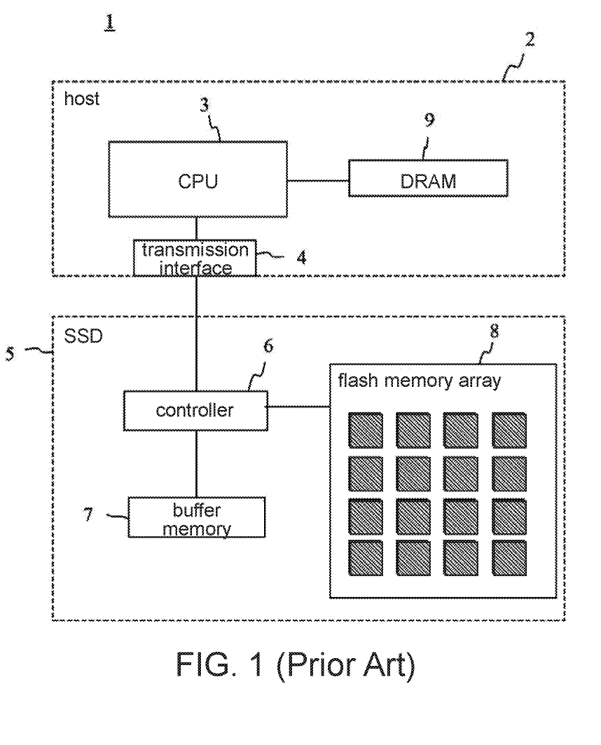

FIG. 2 shows a functional block diagram of storage system of an electronic device of the present invention.

FIG. 3 shows a functional block diagram of the flash partial L2P table mapping method of the present invention.

FIG. 4 shows a functional block diagram of a DRAM partial L2P table mapping method of the present invention.

FIG. 5 shows a functional block diagram of a flash array L2P table mapping method of the present invention.

FIG. 6 shows a functional block diagram of a host partial L2P table mapping method of the present invention.

FIG. 7 shows a flowchart of a method for dynamically storing data of translation layer in a SSD according to a first embodiment of the present invention.

FIG. 8 shows a flowchart of a method for dynamically storing data of translation layer in a SSD according to a second embodiment of the present invention.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

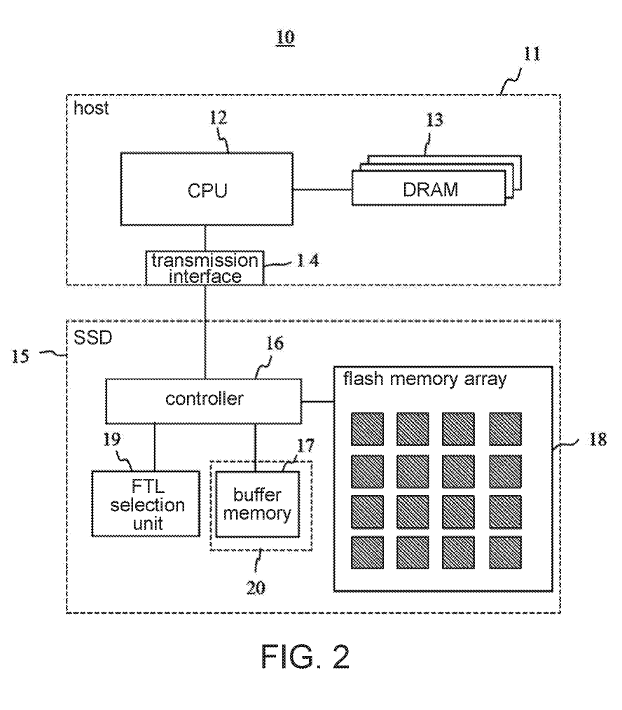

Referring to FIG. 2, a functional block diagram of storage system 10 of an electronic device of the present invention is shown. In storage system 10 of the electronic device of the present invention, the host 11 includes a central processing unit (CPU) 12 and a dynamic random access memory (DRAM) 13, and a transmission interface 14. The CPU 12 works with the DRAM 13 to send a logical address of the data to be accessed to the solid state disk (SSD) 15 which is connected to the transmission interface 14. The SSD 15 includes a controller 16, a buffer memory 17, and a flash memory array 18. The controller 16 works with the buffer memory 17 to receive the logical address of the data to be accessed by the host 11, access the data from the corresponding physical address in the flash memory array 18, and then store the data to the DRAM 13 for the host 11 to use. In the present invention, the SSD 15 additionally includes a translation layer selection unit 19 for dynamically establishing the position of the flash translation layer (FTL) when the SSD 15 is started up.

In the present invention, when storage system 10 of the electronic device starts up the SSD 15, the controller 16 estimates the required capacity of the logical to physical table (L2P) according to the memory capacity of the flash memory array 18, and the translation layer selection unit 19 compares the default capacity of the buffer memory 17 for storing the L2P table with the estimated capacity of the L2P table to decide the position of the FTL. Since the access rate of the buffer memory 17 is 10 time faster than the access rate of the flash memory, the translation layer selection unit 19 takes priority to establish the FTL in the buffer memory 17 belonging to the dynamic random access memory (DRAM) type. If the comparison shows that the default capacity of the buffer memory 17 for storing the L2P table is not smaller than the estimated capacity of the L2P table, then the translation layer selection unit 19 selects the full L2P table mapping method, and sets the all establishment position of the FTL 20 in the buffer memory 17. The translation layer selection unit 19 further notices the controller 16 to read the management data of each data block in the flash memory array 18 to form an L2P table completely stored in the buffer memory 17. When the controller 16 receives the logical address of the data to be accessed by the host 11, the controller 16 controls the FTL to obtain the physical address in which data is stored in the flash memory array 18 with reference to the L2P table stored in the buffer memory 17 to quickly access data from the corresponding flash memory.

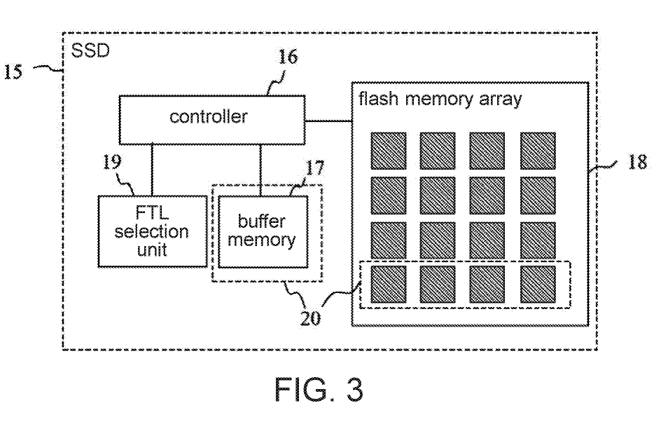

Referring to FIG. 3, a functional block diagram of the flash partial L2P table mapping method of the present invention is shown. When the SSD 15 is started up, if the translation layer selection unit 19 compares the default capacity of the buffer memory 17 for storing the L2P table with the estimated capacity of the L2P table and determines that the default capacity of the buffer memory 17 for storing the L2P table is smaller than the estimated capacity of the L2P table, the translation layer selection unit 19 further checks whether the SSD 15 includes a buffer memory 17 and whether the host reserves a DRAM for the SSD 15 to use. If the SSD 15 includes the buffer memory 17 and the host does not reserve the DRAM, then the translation layer selection unit 19 selects the flash partial L2P table mapping method, and sets a part of the establishment position of the FTL 20 in the buffer memory 17, and the remaining part is established in the flash memory array 18. The translation layer selection unit 19 further notices the controller 16 to read the management data of each data block in the flash memory array 18 to form an L2P table partly stored in the buffer memory 17 and partly stored in the flash memory array 18.

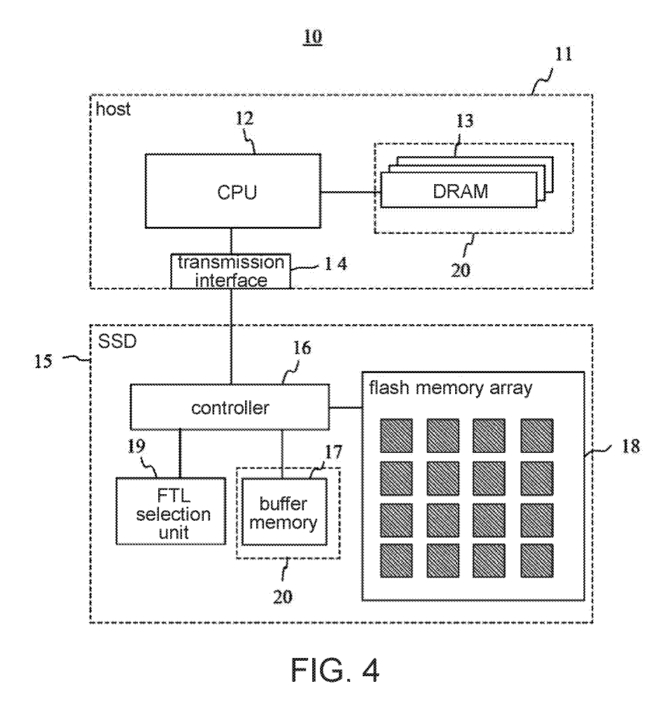

Referring to FIG. 4, a functional block diagram of a DRAM partial L2P table mapping method of the present invention is shown. Since the flash memory array 18 has a slower access rate, some hosts 11 may reserve part of the DRAM 13 for the SSD 15 to use. Although the SSD 15 exchanges data with the DRAM 13 only during the operating gaps of the host 11, the access rate of the DRAM 13 is slower than the access rate of the buffer memory 17. However, the access rate of the DRAM 13 sometimes may be faster than the access rate of the flash memory array 18. Therefore, if the SSD 15 includes the buffer memory 17 and the host 11 reserves the DRAM 13 for the SSD 15 to use, the translation layer selection unit 19 also selects the DRAM partial L2P table mapping method, and sets a part of the establishment position of the FTL 20 in the buffer memory 17, and the remaining part is established in the DRAM 13. The translation layer selection unit 19 further notices the controller 16 to read the management data of each data block in the flash memory array 18 to form an L2P table partly stored in the buffer memory 17 and partly stored in the DRAM 13.

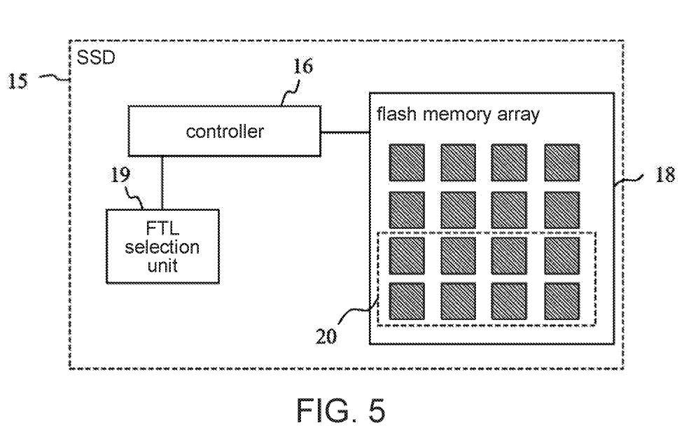

Referring to FIG. 5, a functional block diagram of a flash array L2P table mapping method of the present invention is shown. In the present invention, the translation layer selection unit 19 compares the default capacity of the buffer memory for storing the L2P table with the estimated capacity of the L2P table. When it is determined that the default capacity of the buffer memory for storing the L2P table is smaller than the estimated capacity of the L2P table, if the SSD 15, such as a flash drive or a memory card, does not include the buffer memory and the host does not reserve the DRAM, then the translation layer selection unit 19 selects the flash array L2P table mapping method, and sets all the establishment position of the FTL 20 in the flash memory array 18. The translation layer selection unit 19 further notices the controller 16 to read the management data of each data block in the flash memory array 18 to form an L2P table completely stored in the flash memory array 18. When accessing data, the controller 16 controls the FTL to read a cross-reference relationship of data from the L2P table stored in the flash memory array 18, and directly sends the cross-reference relationship of data to the host. However, in the flash array L2P table mapping method, since the access rate of the flash memory is slower than the access rate of the buffer memory, the access rate of the SSD 15 is reduced.

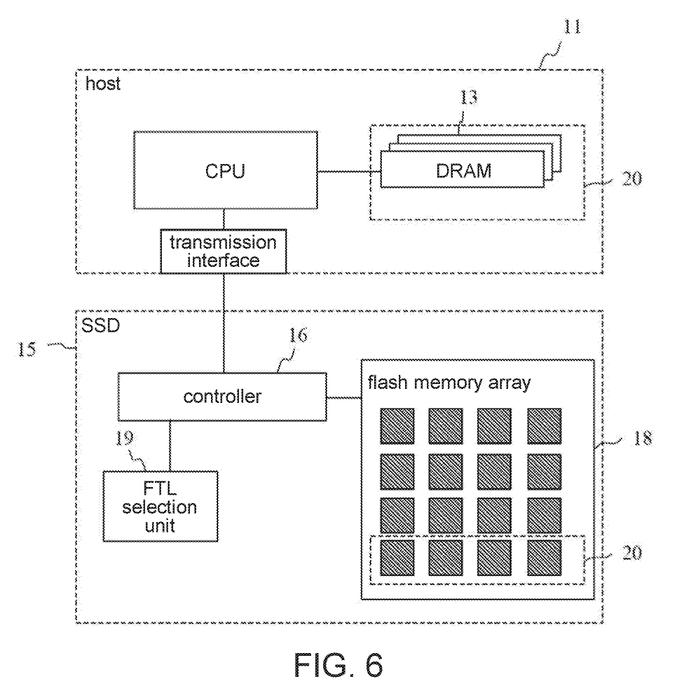

Referring to FIG. 6, a functional block diagram of a host partial L2P table mapping method of the present invention is shown. When the SSD 15 is started up, the translation layer selection unit 19 compares the default capacity of the buffer memory for storing the L2P table with the estimated capacity of the L2P table. When it is determined that the default capacity of the buffer memory for storing the L2P table is smaller than the estimated capacity of the L2P table, and it is further checked and determined that the SSD 15 does not include the buffer memory and that the host 11 reserves the DRAM 13 for the SSD 15 to use, the translation layer selection unit 19 selects the host partial L2P table mapping method, and sets the establishment position of the FTL 20 in the DRAM 13 reserved by the host 11 and sets the remaining part in the flash memory array 18 to increase the access rate. The translation layer selection unit 19 further notices the controller 16 to read the management data of each data block in the flash memory array 18 to form an L2P table partly stored in the DRAM 13, and the remaining part is stored in the flash memory array 18.

In response to the change in the storage medium of the storage system, each time when the SSD is started up, the storage system of the electronic device of the present invention dynamically selects a mapping method, such as full L2P table mapping method, flash partial L2P table mapping method, DRAM partial L2P table mapping method, flash array L2P table mapping method and host partial L2P table mapping method, according to the access rate of the storage medium, and sets the establishment position of the FTL to increase the access rate. In the full mapping methods, such as the full L2P table mapping method and the flash array L2P table mapping method, the data of the FTL is completely stored in the same storage medium, the access rate is not affected at all, and there is no need to adjust the storage position of the hot/cold data. However, in the partial mapping methods, such as the flash partial L2P table mapping method, the DRAM partial L2P table mapping method and the host partial L2P table mapping method, the data of the FTL is stored in different storage medium whose access rates may differ up to 10 times. Under such circumstance, if the position of the FTL for storing the hot and the cold data is not established dynamically and separately, too much hot data may be stored in the storage medium having a slower access rate, not only impeding data access but also deteriorating the overall access efficiency of the SSD.

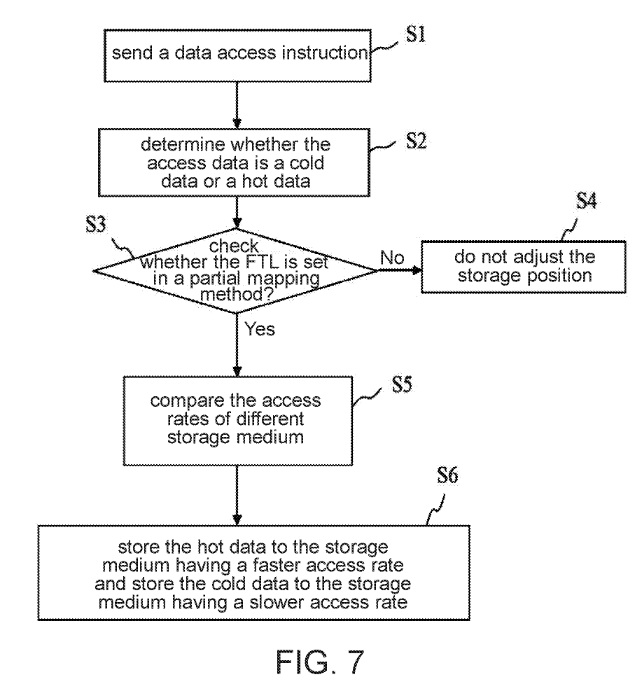

Referring to FIG. 7, a flowchart of a method for dynamically storing data of translation layer in a SSD according to a first embodiment of the present invention is shown. Detailed steps regarding how the SSD dynamically stores the data of translation layer according to the first embodiment of the present invention are disclosed below. In step S1, a data access instruction is sent to an SSD by a host. In step S2, data access times is calculated and compared with a access times threshold by a hot/cold data determination mechanism established in the host or the SSD, wherein the hot/cold data determination mechanism determines the access data as a hot data if the calculated access times exceeds the access times threshold and determines the access data as a cold data if the calculated access times does not exceed the access times threshold. In step S3, when the SSD is started up, whether the FTL dynamically established by the SSD is set in a partial mapping method is checked. If the FTL is set in a non-partial mapping method, then the method proceeds to step S4, and there is no need to adjust the storage position of the hot/cold data because the data of the FTL is all stored in the same storage medium. If the FTL is set in a partial mapping method, then the method proceeds to step S5, access rates of different storage medium are compared according to the partial mapping method set by the FTL to decide the ranking of the access rates of the storage medium. In step S4, the storage position of the hot data of the FTL is adjusted to the storage medium having a faster access rate to expedite data access and the storage position of the cold data of the FTL is adjusted to the storage medium having a slower access rate according to the partial mapping method dynamically set during the start-up, wherein the hot data is the data often accessed, and the cold data is the data rarely accessed. Although the access rate of the cold data is slowed down, the overall access rate of the SSD is only slightly affected because only the access of a small amount of data is affected.

Refer to FIG. 3. In the present invention, during the start-up of the SSD 15, suppose a part of the buffer memory 17 of the SSD 15 is damaged, and the translation layer selection unit 19 dynamically selects the flash partial L2P table mapping method for the FTL. In the flash partial L2P table mapping method, the data of the FTL is partly stored in the buffer memory 17 of the SSD and the remaining part is stored in the flash memory array 18, wherein the access rate of the buffer memory 17 is 10 times faster than the access rate of the flash memory array 18. During the establishment of the FTL, first of all, whether the access data is a hot data or a cold data is determined by a hot/cold data determination mechanism. If the access data is determined as a hot data, then the access data is stored in the buffer memory 17. If the access data is determined as a cold data, then the access data is stored in the flash memory array 18 to increase the access rate.

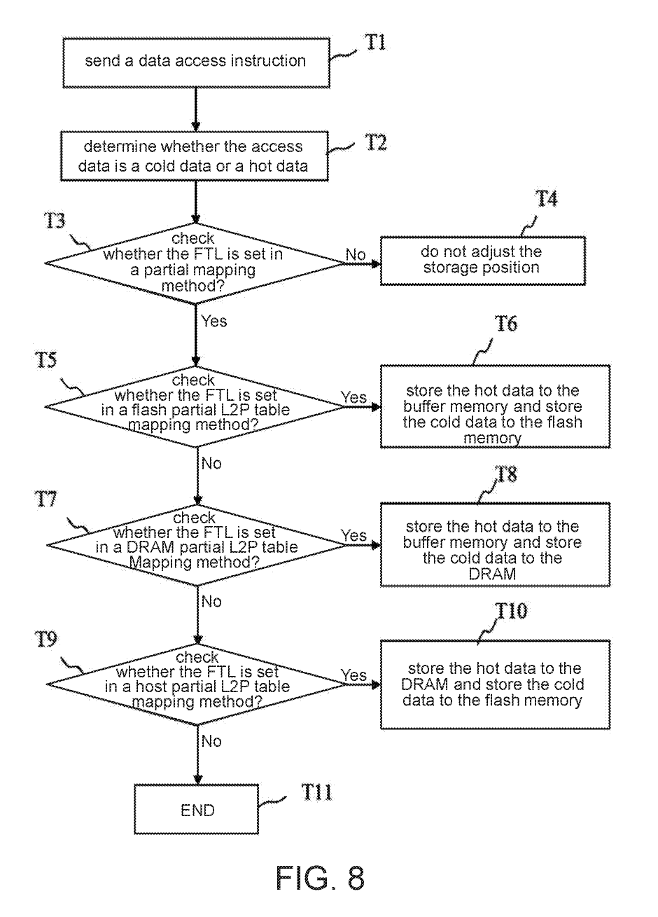

Referring to FIG. 8, a flowchart of a method for dynamically storing data of translation layer in a SSD according to a second embodiment of the present invention is shown. Detailed steps regarding how the SSD dynamically stores the data of translation layer in each mapping method according to the second embodiment of the present invention are disclosed below. In step T1, a data access instruction is sent to an SSD by a host. In step T2, whether the access data is a hot data or a cold data is determined by a hot/cold data determination mechanism. In step T3, whether the FTL dynamically established by the SSD is set in a partial mapping method is checked. If the FTL is not set in a partial mapping method, then the method proceeds to step T4, there is no need to adjust the storage position of the hot/cold data. If the FTL is set in a partial mapping method, then the method proceeds to step T5, whether the FTL dynamically established by the SSD is set in the flash partial L2P table mapping method is checked. If the FTL is set in the flash partial L2P table mapping method, then the method proceeds to step T6, the access rates of between the buffer memory and the flash memory array are compared. If the access rate of the buffer memory is faster than the access rate of the flash memory array, then the storage position of the hot data of the FTL is adjusted to the buffer memory and the storage position of the cold data of the FTL is adjusted to the flash memory array.

If the FTL is not set in the flash partial L2P table mapping method, then the method proceeds to step T7, whether the FTL dynamically established by the SSD is set in the DRAM partial L2P table mapping method is checked. If the FTL is set in the DRAM partial L2P table mapping method, then the method proceeds to step T8, the access rates of between the buffer memory and the DRAM are compared. If the buffer memory is faster than the access rate of the DRAM, the storage position of the hot data of the FTL is adjusted to the buffer memory and the storage position of the cold data of the FTL is adjusted to the DRAM.

If the FTL is not set in the DRAM partial L2P table mapping method, then the method proceeds to step T9, whether the FTL dynamically established by the SSD is set in the host partial L2P table mapping method is checked. If the FTL is set in the host partial L2P table mapping method, then the method proceeds to step T10, the access rates between the DRAM and the flash memory array are compared. In the present embodiment, it is assumed that the access rate of the DRAM is faster than the access rate of the flash memory array, so the storage position of the hot data of the FTL is adjusted to the DRAM and the storage position of the cold data of the FTL is adjusted to the flash memory array. However, the access rate of the DRAM also depends on the operating frequency of the host, and the assumption can be revised as: if the access rate of the flash memory array is faster than the access rate of the DRAM, then the storage position of the hot data of the FTL is adjusted to the flash memory array and the storage position of the cold data of the FTL is adjusted to the DRAM. If the FTL is not set in the host partial L2P table mapping method, then the method proceeds to step T11, the method terminates.

In the method for dynamically storing data of translation layer in a SSD according to the second embodiment of the present invention, the sequence of steps T5 and T6, steps T7 and T8, and steps T9 and T10 of can be flexibly adjusted and the same effect still can be achieved. For example, the sequence of step T5 of checking whether the FTL dynamically established by the SSD is set in the flash partial L2P table mapping method and its subordinate step T6 of adjusting the hot/cold data storage position, step T7 of checking whether the FTL dynamically established by the SSD is the DRAM partial L2P table mapping method and its subordinate step T8 of adjusting the hot/cold data storage position, and step T9 of checking whether the FTL dynamically established by the SSD is the host partial L2P table mapping method and its subordinate step T10 of adjusting the storage position of the hot/cold data, can be flexibly adjusted.

The present invention provides a method for dynamically storing data of translation layer in a SSD of the present invention. When the SSD is started up, the mapping method of the FTL is dynamically selected, and the access rates of different storage medium used in each mapping method are compared and the storage position of the hot/cold data in the FTL is dynamically adjusted to increase the access rate of the SSD. That is, the hot data is dynamically stored in the storage medium having a faster access rate, and the cold data is dynamically stored in the storage medium having a slower access rate, to increase the access rate of the SSD.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A method for dynamically storing data of translation layer in a solid state disk (SSD), comprising:
sending a data access instruction to the SSD by a host;
determining whether access data is a cold data or a hot data;
checking whether a flash translation layer (FTL) dynamically established by the SSD is set in a partial mapping method;
comparing the access rates of different storage medium in the partial mapping method to determine the ranking of the access rates of the storage medium;
adjusting the storage position of the hot data of the FTL to the storage medium having a faster access rate and adjusting the storage position of the cold data of the FTL to the storage medium having a slower access rate.

2. The method for dynamically storing data of translation layer in the SSD according to claim 1, wherein a hot/cold data determination mechanism is disposed, the hot/cold data determination mechanism presets an access times threshold, calculates data access times, and further determines the access data as a hot data if the calculated access times exceeds the access times threshold and determines the access data as a cold data if the calculated access times does not exceed the access times threshold.

3. The method for dynamically storing data of translation layer in the SSD according to claim 2, wherein the hot/cold data determination mechanism is established in the host or the SSD.

4. The method for dynamically storing data of translation layer in the SSD according to claim 1, wherein the partial mapping method comprises flash partial L2P table mapping method, dynamic random access memory (DRAM) partial L2P table mapping method and host partial L2P table mapping method.

5. The method for dynamically storing data of translation layer in the SSD according to claim 1, wherein when the FTL is set in a non-partial mapping method, the storage position of the hot/cold data is not adjusted.

6. The method for dynamically storing data of translation layer in the SSD according to claim 5, wherein the non-partial mapping method comprise full L2P table mapping method and flash array L2P table mapping method which are dynamically selected.

7. A method for dynamically storing data of translation layer in a solid state disk (SSD), comprising:
sending a data access instruction to the SSD by a host;
determining whether access data is a cold data or a hot data;
checking whether the FTL dynamically established by the SSD is set in a partial mapping method;
further checking whether the FTL dynamically established by the SSD is set in the flash partial L2P table mapping method; wherein when it is checked and determined that the FTL dynamically established by the SSD is set in the flash partial L2P table mapping method, the access rates between a buffer memory and a flash memory array are compared, if the access rate of the buffer memory is faster than the access rate of the flash memory array, the storage position of the hot data of the FTL is adjusted to the buffer memory and the storage position of the cold data of the FTL is adjusted to the flash memory array.

8. The method for dynamically storing data of translation layer in the SSD according to claim 7, wherein when it is checked and determined that the FTL is set in a non-partial mapping method, the storage position of the hot/cold data is not adjusted.

9. The method for dynamically storing data of translation layer in the SSD according to claim 7, wherein when it is checked and determined that the FTL is not set in the flash partial L2P table mapping method and the FTL dynamically established by the SSD is set in the DRAM partial L2P table mapping method, the access rates between the buffer memory and a DRAM are compared, if the access rate of the buffer memory is faster than the access rate of the DRAM, then the storage position of the hot data of the FTL is adjusted to the buffer memory and the storage position of the cold data of the FTL is adjusted to the DRAM.

10. The method for dynamically storing data of translation layer in the SSD according to claim 9, wherein when it is checked and determined that the FTL is not set in the DRAM partial L2P table mapping method and the FTL dynamically established by the SSD is set in the host partial L2P table mapping method, the access rates between the DRAM and the flash memory array are compared.

11. The method for dynamically storing data of translation layer in the SSD according to claim 10, wherein if the access rate of the DRAM is faster than the access rate of the flash memory array, the storage position of the hot data of the FTL is adjusted to the DRAM and the storage position of the cold data of the FTL is adjusted to the flash memory array.

12. The method for dynamically storing data of translation layer in the SSD according to claim 10, wherein if the access rate of the flash memory array is faster than the access rate of the DRAM, the storage position of the hot data of the FTL is adjusted to the flash memory array and the storage position of the cold data of the FTL is adjusted to the DRAM.
